(19) United States
(12) Patent Application Publication
(10) Pub. No.: US 2026/0228953 A1
(43) Pub. Date: Aug. 6, 2026

(54) METHOD AND A SYSTEM FOR CREATING AN AUDIO-ENABLED SVG ANIMATIONS USED AS LEARNING CONTENTS

(71) Applicant: Owlyard Inc., Frederick, MD (US)

(72) Inventors: Joydip GHOSH, Frederick, MD (US); Sankardas ROY, Perrysburg, OH (US)

(73) Assignee: Owlyard Inc., Frederick, MD (US)

(21) Appl. No.: 19/462,074

(22) Filed: Jan. 28, 2026

Related U.S. Application Data
(60) Provisional application No. 63/753,842, filed on Feb. 4, 2025.

(51) Int. Cl. G06T 13/20; G06F 16/683; G06F 40/154; G10L 19/00

(52) U.S. Cl. CPC G06T 13/205; G06F 16/683; G06F 40/154; G10L 19/0017

(57) ABSTRACT

Systems, methods are provided for creating and viewing audio-enabled scalable vector graphics (SVG) animations as learning contents for online education. a web-based application (“Content editor”) is provided that deploys a digital canvas to the educators enabling them to draw arbitrary shapes, type texts/symbols and record their voice simultaneously, as needed, to create learning contents. The application then collects all the data produced from the canvas, converts these to an animated Scalable Vector Graphics (ASVG) format with the recorded voice integrated and synchronized. This audio-enabled animated SVG offers an online classroom-type experience to learners and is deployed through a custom-built audio-visual viewer (“Content viewer”). The content editor and the content viewer can be integrated with any online platform and is capable of rendering simple classroom-standard teaching actions (drawing strokes, typing texts and verbal communications) to an audio-visual learning content.

### CROSS REFERENCE

The present Application for Patent claims the benefit of U.S. Provisional Patent Application No. 63/753,842 by Joydip Ghosh, entitled “A METHOD AND A SYSTEM FOR CREATING AN AUDIO-ENABLED SVG ANIMATIONS USED AS LEARNING CONTENTS,” filed Feb 04, 2025, assigned to the assignee hereof, and expressly incorporated by reference herein.

### TECHNICAL FIELD

The present subject matter is in general related to a web-based application and particularly to a method and a system to create and view audio-enabled scalable vector graphics (SVG) animations as learning contents for online education.

### BACKGROUND

Online learning requires educators/presenters to create audio-visual digital learning contents that can be shared through web-based platforms. Online classes using animation offer several advantages that enhance learning experiences, making education more effective and engaging. Animated content is visually stimulating and helps to capture students’/learners’ attention. The dynamic nature of animation can keep learners more engaged compared to static text or slides. Overall, online classes/ presentations enhanced through animation make learning more accessible, engaging, and effective by tapping into the power of visual storytelling, interaction, and creativity. However, creating animated videos as learning content is a challenging task due to several factors, including technical complexity, resource demands, and the need for a high memory size. Memory usage can be a significant issue when creating or consuming animated videos, particularly in the context of online learning content. Particularly, memory usage issues are a common concern with web-based animated videos, particularly because the animations are played and processed directly in the browser, which can impact both memory (RAM) and CPU usage.

Therefore, there exists a need for a technique that addresses at least the above identified problems and generates a web-based application to create and view audio-enabled scalable vector graphics (SVG) animations as learning contents for online education.

### SUMMARY

According to non-limiting embodiments or aspects, a method for creating a learning content for a client device is disclosed. The method comprises receiving a plurality of user inputs on a digital canvas deployed by a web-based application. The method further comprises simultaneously generating a visual representation of the plurality of user inputs on the digital canvas in real time. The method further comprises generating an audio-integrated animated Scalable Vector Graphics (SVG) format as an output to create the learning content.

In yet another non-limiting embodiment, wherein the plurality of user inputs may comprise at least one of: drawing shapes, typing texts and recording voice of the user.

In yet another non-limiting embodiment of the present disclosure, wherein to generate the audio-integrated animated Scalable Vector Graphics (SVG) format the method comprises generating a visual metadata to describe a plurality of user visual actions onto the digital canvas, wherein the plurality of user visual actions is derived from the received plurality of the user inputs. Further, the method comprises generating an audio metadata by encoding a plurality of the audio-chunks received in the plurality of user inputs, wherein the plurality of the audio-chunks is produced by the user while recording user’s voice.

In yet another non-limiting embodiment of the present disclosure, wherein to generate the audio-integrated animated SVG format the method further comprises storing generated content in a file having an .asvg extension. The .asvg file being a JSON-based format, comprises at least one of a title field representing a title of the content, a duration field representing the length of the audio-visual content, a visual data object and an audio data field comprising an encoded audio representation. The visual data object further comprises dimensions of recorded screen, coordinate arrays representing positions of strokes or actions, timing arrays representing start and end times for each stroke or action, arrays representing tool type, color, and size information for each stroke or action and arrays representing text typed during each stroke or action.

In yet another non-limiting embodiment of the present disclosure, wherein to generate the audio-integrated animated SVG format the method further comprises recording a panning action on the digital canvas. The method further comprises encoding the recorded panning action with a corresponding visual snapshot of the digital canvas, to enable reconstruction of the panning action during reconstruction of the animated SVG file at a server.

In yet another non-limiting embodiment of the present disclosure, the method comprises creating a JavaScript Object Notation (JSON) document that comprises the audio metadata and the visual metadata. Moving further, the method comprises determining if a size of the JSON document is larger than a pre-defined size. Upon determining that the size of the JSON document is larger than the pre-defined size, the method further comprises partitioning the JSON document into a plurality of smaller chunks, such that the size of each chunk does not exceed the pre-defined size, wherein partitioning the JSON document into smaller chunks comprises assigning sequence identifiers to each chunk for accurate reconstruction at a server. Finally, the method comprises transmitting the plurality of smaller chunks to the server.

In yet another non-limiting embodiment of the present disclosure, wherein the audio-integrated animated SVG format is generated using a Cascading Style Sheets (CSS) animation technique for rendering visual actions.

In yet another non-limiting embodiment of the present disclosure, wherein the visual metadata further comprises arrays representing tool type, color, and size information for each stroke or action

In yet another non-limiting embodiment of the present disclosure, wherein the audio metadata is encoded using a compression technique selected at least from a group of Moving Picture Experts Group (MPEG) ‑1 Audio Layer 3 (MP3), Advanced Audio Coding (AAC), or Opus formats to reduce file size.

In yet another non-limiting embodiment of the present disclosure, wherein the .asvg file further comprises a checksum field for verifying integrity of the content during transmission

In yet another non-limiting embodiment of the present disclosure, the method comprises applying AI-enabled post-processing to refine one or more visual shapes and remove unnecessary pauses from the audio data.

According to non-limiting embodiments or aspects, a method for creating at a server is disclosed. The method comprises receiving a plurality of chunks of a JSON document, from a client device. Further, the method comprises reconstructing the JSON document by combining the plurality of smaller chunks. The method comprises extracting an audio metadata and the visual metadata from the reconstructed JSON document. Finally, the method comprises performing a plurality of operations to create an enhanced JSON document as the learning content.

In yet another non-limiting embodiment of the present disclosure, wherein to perform the plurality of operations to create the enhanced JSON document, the method comprises at least one of the following. The method comprises refining one or more visual shapes defined in the reconstructed JSON document for making the one or more visual shapes smoother. Further, the method comprises refining audio quality defined in the reconstructed JSON document and removing unnecessary pauses from the audio data. The method further comprises adjusting duration of each stroke for synchronising visual part of the reconstructed JSON document with the audio part of the reconstructed JSON document, wherein adjusting the duration of each stroke comprises mapping stroke timestamps to corresponding audio timestamps using a synchronization technique.

In yet another non-limiting embodiment of the present disclosure, wherein to reconstruct the JSON document the method comprises validating sequence identifiers of the plurality of chunks to ensure accurate reconstruction.

In yet another non-limiting embodiment of the present disclosure, wherein to extract the audio metadata and the visual metadata, the method further comprises verifying integrity of the reconstructed JSON document using a checksum or hash value.

In yet another non-limiting embodiment of the present disclosure, wherein to perform the plurality of operations the method further comprises compressing the enhanced JSON document using a lossless compression technique prior to storage or transmission

In yet another non-limiting embodiment of the present disclosure, wherein to refine audio quality the method comprises applying noise reduction and dynamic range compression to the audio data.

In yet another non-limiting embodiment of the present disclosure, wherein to refine one or more visual shapes the method further comprises applying a smoothing technique using an optimized exponential moving average method.

In yet another non-limiting embodiment of the present disclosure, the method further comprises storing the enhanced JSON document in a database with a unique identifier for retrieval by an end user device.

In yet another non-limiting embodiment of the present disclosure, wherein the enhanced JSON document includes metadata fields representing version control information for tracking edits.

In yet another non-limiting embodiment of the present disclosure, the method further comprises encrypting the enhanced JSON document prior to transmission to an end user device.

In yet another non-limiting embodiment of the present disclosure, the method further comprises generating a preview of the enhanced JSON document as a CSS-animated SVG for validation before deployment.

According to non-limiting embodiments or aspects, a method for creating a learning content for an end user’s device is disclosed. The method comprises transmitting a request to view a specific content on a user interface deployed by a web-based application. The method further comprises receiving a plurality of chunks pertaining to a JSON document, from a server in response to the request. The method further comprises re-creating the JSON document by combining the plurality of smaller chunks and extracting a visual metadata from the re-created JSON document and transforming the visual metadata to a Cascading Style Sheets (CSS) animated SVG and playing the CSS-animated SVG. Further, the method comprises extracting the audio metadata from the re-created JSON document and converting the audio metadata to a plurality of audio blobs. The method further comprises controlling playing of the CSS-animated SVG and the plurality of audio blobs on a display of the end user’s device such that the CSS-animated SVG audio and the plurality of audio blobs are being played in synchronization on the display of the end user’s device.

According to non-limiting embodiments or aspects, a server for creating a learning content is disclosed. The server comprises a memory and a processor which is electronically coupled to the memory. The processor receives a plurality of chunks of a JSON document, from a user front end module of a web-based application hosted by the server. Further, the processor reconstructs the JSON document by combining the plurality of smaller chunks. The processor extracts an audio metadata and the visual metadata from the reconstructed JSON document. Finally, the processor performs a plurality of operations to create an enhanced JSON document as the learning content.

In yet another non-limiting embodiment of the present disclosure, wherein to perform the plurality of operations to create the enhanced JSON document, the processor performs at least one of the following such as refining one or more visual shapes defined in the reconstructed JSON document for making the one or more visual shapes smoother, refining audio quality defined in the reconstructed JSON document and removing unnecessary pauses from the audio data, adjusting duration of each stroke for synchronising visual part of the reconstructed JSON document with the audio part of the reconstructed JSON document, wherein adjusting the duration of each stroke comprises mapping stroke timestamps to corresponding audio timestamps using a synchronization technique.

In yet another non-limiting embodiment of the present disclosure, wherein to reconstruct the JSON document the processor validates sequence identifiers of the plurality of chunks to ensure accurate reconstruction.

In yet another non-limiting embodiment of the present disclosure, wherein to extract the audio metadata and the visual metadata, the processor further verifies integrity of the reconstructed JSON document using a checksum or hash value.

In yet another non-limiting embodiment of the present disclosure, wherein to perform the plurality of operations the processor compresses the enhanced JSON document using a lossless compression technique prior to storage or transmission.

In yet another non-limiting embodiment of the present disclosure, wherein to refine audio quality the processor applies noise reduction and dynamic range compression to the audio data.

In yet another non-limiting embodiment of the present disclosure, wherein to refine one or more visual shapes the processor further applies a smoothing technique using an optimized exponential moving average method.

In yet another non-limiting embodiment of the present disclosure, wherein to store the enhanced JSON document, the processor saves the enhanced JSON document in a database with a unique identifier for retrieval by an end-user device.

In yet another non-limiting embodiment of the present disclosure, wherein the enhanced JSON document includes metadata fields representing version control information for tracking edits.

In yet another non-limiting embodiment of the present disclosure, wherein to transmit the enhanced JSON document the processor further encrypts the enhanced JSON document prior to transmission to an end user device.

In yet another non-limiting embodiment of the present disclosure, wherein to validate the enhanced JSON document before deployment, the processor generates a preview of the enhanced JSON document as a CSS-animated SVG.

According to non-limiting embodiments or aspects, a non-transitory computer-readable medium storing instructions, is described. The instructions when executed by one or more processors of a server, cause the server to perform operations comprising receiving a plurality of user inputs on a digital canvas deployed by a web-based application hosted at the server, simultaneously generating a visual representation of the plurality of user inputs on the digital canvas in real time and generating an audio-integrated animated Scalable Vector Graphics (SVG) format as an output to create learning content.

According to non-limiting embodiments or aspects, a non-transitory computer-readable medium storing instructions, is described. The instructions when executed by one or more processors of a server, cause the server to perform operations comprises receiving a plurality of chunks of a JSON document from a client device, reconstructing the JSON document by combining the plurality of chunks, reconstructing the JSON document by combining the plurality of chunks and extracting audio metadata and visual metadata from the reconstructed JSON document.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) of a reference number identify the figure in which the reference number first appears. The same numbers are used throughout the figures to reference features and components. Some embodiments of device or system and/or methods in accordance with embodiments of the present subject matter are now described, by way of example only, and with reference to the accompanying figures, in which:

FIG. 1 illustrates a schematic overview of the workflow that converts user input to an animated SVG, in accordance with some embodiments of the present disclosure.

FIG. 2 illustrates an exemplary block diagram of a system for creating the audio-enabled animated SVG, in accordance with some embodiments of the present disclosure.

FIG. 3 illustrates an exemplary flow diagram for content editing workflow at client side (user 1 front end), in accordance with some embodiments of the present disclosure.

FIG. 4 illustrates an exemplary flow diagram for data processing at server side in accordance with some embodiments of the present disclosure.

FIG. 5 represents an exemplary flow diagram for content viewing workflow at end user’s side (user 2 front end), according to some non-limiting embodiments or aspects.

FIG. 6 depicts an exemplary block diagram for illustrating structure of an audio-integrated animated Scalable Vector Graphics (SVG) file, stored with an .asvg extension, in accordance with some embodiments of the present disclosure.

FIG. 7 illustrates a flowchart of an exemplary method for content editing workflow at client side (user 1 front end) in accordance with some embodiments of the present disclosure.

FIG. 8 illustrates a flowchart of an exemplary method for data processing at server side, in accordance with some embodiments of the present disclosure.

FIG. 9 illustrates a flowchart of an exemplary method for content viewing workflow at end user’s side (user 2 front end), in accordance with some embodiments of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DESCRIPTION OF THE DISCLOSURE

It is to be understood that the present disclosure may assume various alternative variations and step sequences, except where expressly specified to the contrary. It is also to be understood that the specific devices and processes illustrated in the attached drawings and described in the following specification are simply exemplary and non-limiting embodiments or aspects. Hence, specific dimensions and other physical characteristics related to the embodiments or aspects disclosed herein are not to be considered as limiting.

In the present document, the word "exemplary" is used herein to mean "serving as an example, instance, or illustration." Any embodiment or implementation of the present subject matter described herein as "exemplary" is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises… a” does not, without more constraints, preclude the existence of other elements or additional elements in the device or system or apparatus.

The terms "an embodiment", "embodiment", "embodiments", "the embodiment", "the embodiments", "one or more embodiments", "some embodiments", and "one embodiment" mean "one or more (but not all) embodiments of the invention(s)" unless expressly specified otherwise.

The terms "including", "comprising", “having” and variations thereof mean "including but not limited to" unless expressly specified otherwise.

As used herein, the term “User 1” may refer to the user who creates the learning content and upload for the end user for example educator, teacher, trainer, instructor etc. “User 2” may refer to an “end user” such as student, learner etc who may request and view the content.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a personal digital assistant (PDA), and/or other like devices. A computing device may also be a desktop computer or other form of non-mobile computer.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously recited device, server, or processor that is recited as performing a previous step or function, a different device, server, or processor, and/or a combination of devices, servers, and/or processors. For example, as used in the specification and the claims/ examples, a client device, a server, or an end user’s device that is recited as performing a first step or a first function may refer to the same or different device, server, or processor recited as performing a second step or a second function.

Technique(s) for rendering audio-integrated animated learning content at an end user’s device is disclosed. The technique includes transmitting a request to access specific content via a user interface of a web-based application and receiving, in response, a plurality of data chunks corresponding to a JSON document from a server. The technique further comprises reconstructing the JSON document by combining the received chunks and extracting visual metadata to generate a Cascading Style Sheets (CSS)-based animated Scalable Vector Graphics (SVG) for display. Additionally, the techniques include extracting audio metadata from the reconstructed JSON document, converting the audio metadata into a plurality of audio blobs, and synchronizing playback of the CSS-animated SVG with the audio blobs on the end user’s device. This synchronization ensures that the visual and audio components are rendered in real time to deliver an interactive and immersive learning experience.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

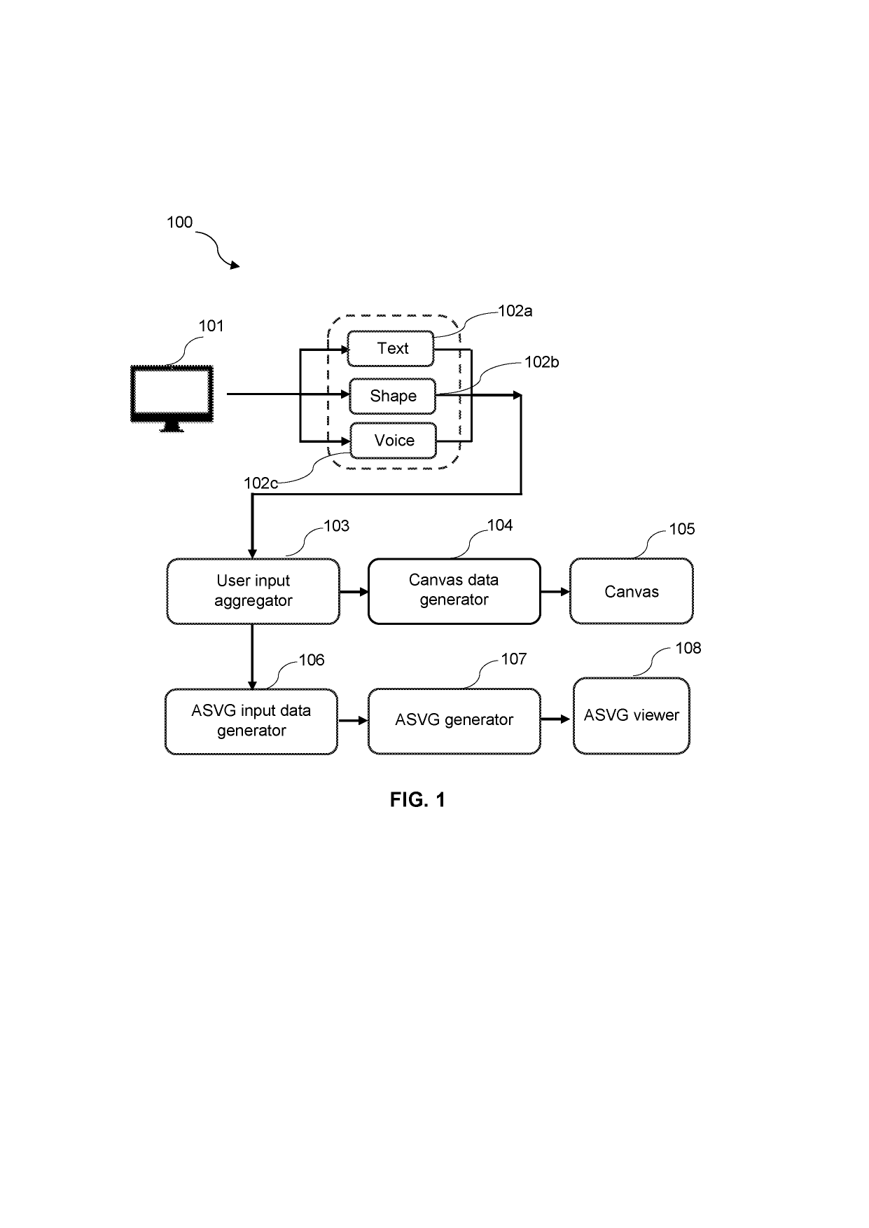

Referring now to FIG. 1, FIG. 1 illustrates a schematic overview of the workflow that converts user input to an animated SVG, in accordance with some embodiments of the present disclosure. The schematic overview of the workflow may be implemented with one or more computing devices, systems, and/or methods as described herein. As shown in FIG. 1, the overview may include different components for example but not limited thereto, a user input system 101, a user input aggregator 103, a canvas data generator 104, a canvas 105, an animated Scalable Vector Graphics (ASVG) input data generator 106, ASVG generator 107 and a ASVG viewer 108. The different components may interconnect (e.g., establish a connection to communicate) via wired connections, wireless connections, or a combination of wired and wireless connections as per the implementation requirement of the present disclosure.

In an exemplary embodiment, the user input system 101 receives a plurality of inputs from a user. In an example without limitation, the user may refer to the user who creates the learning content and upload for the end user. In an example without limitation, the user may include an educator, teacher, trainer, instructor etc. (whoever creates the learning content) and the end user may include student, learner etc. (whoever access the learning content for learning purpose). The plurality of inputs may include but not limited thereto, a text 102a, a shape 102b (drawn using mouse or stylus or other similar tools) and voice 102c (recorded through the microphone). As the plurality of inputs are generated, the plurality of inputs is passed to the user input aggregator 103, which then sent to the canvas data generator 104 in order to generate the visual of the user's actions on the digital canvas 105 simultaneously. While generating the visual representation of the of the user's actions on the digital canvas, the digital canvas may include but not limited thereto smart features such as it can detect whether the user is drawing a straight line or a curved line. If the line is not entirely straight, but the error (per unit length) is within a predefined limit, it can correct the line. Further, it can eliminate jitters/noises to make a smooth curve. When the use is done with the process, the user input aggregator 103 passes the plurality of inputs to the ASVG input generator 106 that filters the plurality of inputs in order to produce the required input to the ASVG generator 107 to generate ASVG and finally generated ASVG is sent to the ASVG viewer 108.

The number and arrangement of components/blocks as shown in FIG. 1 are provided as an example. There may be additional devices, fewer devices or differently arranged devices than those shown in FIG. 1. Additionally, or alternatively, a set of devices (e.g., one or more computing devices) may perform one or more functions/components described in the overview.

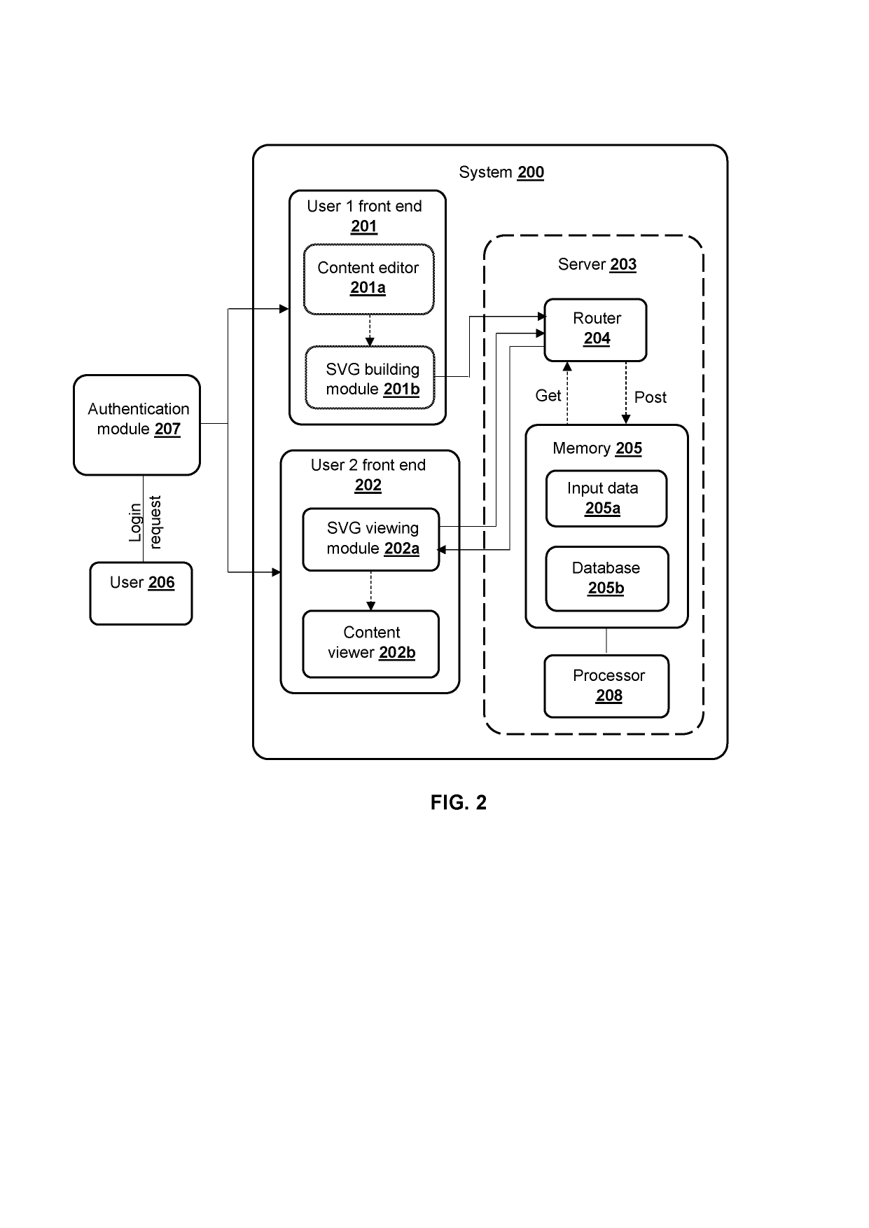

Referring now to FIG. 2, shown is a diagram of a system 200 for creating the audio-enabled animated SVG, in accordance with some embodiments of the present disclosure. The system 200 may comprise user1 front end 201, user2 front end 202 and a server 203 as an example. In context of the present disclosure, the user 1 front end 201 may refer to client-side interface designed for educators or content creators to develop interactive learning materials. This front end provides a digital canvas within a web-based application, enabling simultaneous input of text, graphical strokes, and audio recordings. It facilitates real-time rendering of user actions on the canvas, ensuring immediate feedback during content creation. The User 1 Front End serves as the primary environment for generating audio-integrated animated Scalable Vector Graphics (SVG) content, which is later processed and optimized for delivery to end users.

Further, in context of the present disclosure, the user 2 front end 202 may represent interface deployed on an end user’s device, such as a student’s computer or mobile device, for viewing and interacting with the audio-enabled animated SVG content. This front end reconstructs the content received from the server and renders it as a CSS-animated SVG synchronized with audio playback. It provides an intuitive viewing experience, allowing learners to engage with lightweight, scalable, and interactive educational content without requiring high bandwidth or specialized software.

Although not explicitly illustrated in FIG. 2, the system 200 also includes a web-based application that functions as the underlying platform integrating and coordinating the operations of the components like user 1 front end 201, the user 2 front end 202, and the server 203 described herein. In context of the present disclosure, the web-based application provides a digital canvas for educators to create content and facilitates real-time rendering of user inputs, including text, graphical strokes, and audio. It also manages the generation of JSON-based .asvg files, their transmission to the server 203 for processing, and subsequent delivery to end-user devices for synchronized playback. By serving as the central interface, the web-based application ensures seamless communication between client and server modules, enabling lightweight, scalable, and interactive learning experiences across diverse devices and network environments.

In operation, the user 206 who wants to create content may access a web-based application through a secure network connection, such as the Internet, using a standard web browser on any compatible device (desktop, laptop, tablet, or smartphone). The application is hosted on a server and is accessible via a Uniform Resource Locator (URL) provided by the platform. Upon navigating to the URL, the user sends a login request to an authentication module 207, which validates the credentials and grants access to the user 1 front end 201 for content editing. The user 1 front end 201 comprises a content editor 201a deployed within the web-based application, which is configured to receive multiple inputs such as text, graphical strokes, and voice recordings simultaneously from the user/client 206. The output generated by the content editor 201a is then processed by the SVG building module 201b, which converts the captured inputs into an audio-integrated animated Scalable Vector Graphics (SVG) format for further processing. The animated SVG may be Cascading Style Sheets (CSS) animated SVG. This web-based architecture ensures cross-platform compatibility and eliminates the need for installing dedicated software, thereby enabling lightweight and scalable access for educators.

In some non-limiting exemplary embodiments or aspects, the SVG building module 201b may be implemented in hardware, firmware, or a combination of hardware and software. In an example of non-limiting embodiment, the SVG building module 201b may be implemented by a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function.

Further, for viewing the content, the end user such as a student or learner may access the web-based application through a secure network connection using a standard web browser on any compatible device, including desktops, laptops, tablets, or smartphones. Upon navigating to the URL, the end user sends a request to view specific learning content through the user 2 front end 202 deployed within the web-based application.

The user 2 front end 202 may include a SVG viewing module 202a which is used to recreate the animated SVG on the user2 side. The user 2 front end 202 may include content viewer 202b which is used by the user 2 to play/replay/pause/start or control the animated SVG video of the learning content. The user 2 front end 202 is configured to reconstruct the JSON-based .asvg file received from the server 203, transform the visual metadata into a CSS-animated SVG, and decode the audio metadata into playable audio blobs. The content viewer 202b ensures synchronized playback of the visual and audio components, providing an interactive and immersive learning experience. This web-based architecture eliminates the need for specialized software installation and supports cross-platform compatibility, enabling learners to access lightweight, scalable content seamlessly.

In some non-limiting exemplary embodiments or aspects, the SVG viewing module 202a may be implemented in hardware, firmware, or a combination of hardware and software. In an example, the SVG viewing module 202a may be implemented by a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function.

Referring to FIG. 2 again, the server 203 may manage and distribute resources across a network, and is used for a variety of tasks such as data creation, data storage, data distribution etc. The server 203 may comprise a router 204 to channelize data to and from the user2 front end and user 1 front end respectively. The server 203 may also include a processor 208 to perform various task of the server, a memory 205, used to store the data received from user 1 and user 2 front end.

In one implementation, the processor 208 may be implemented as one or more microprocessors, microcomputers, microcontrollers, digital signal processors, central processing units, state machines, logic circuitries, and/or any devices that manipulate signals based on operational instructions. Among other capabilities, the processor 208 may be configured to fetch and execute computer-readable instructions and other information stored in the memory 205.

In some implementations, memory 205 may include one or more non-transitory computer-readable storage media, such as RAM, ROM, EEPROM, EPROM, one or more memory devices, flash memory devices, etc., and combinations thereof. In an embodiment, input data 205a may be stored within the memory 205 in the form of various data structures. In a non-limiting example, input data 203a refers to the plurality of inputs relating to text, shape and voice received from the user through user 1 front end. The memory 205 may also include maintaining a database 205b for storing temporary data and temporary files, generated by the SVG building module 201b or any other parts of the system 200 including the SVG viewing module 202a, router 203 for performing the various functions of the present disclosure.

The system 200 may perform one or more processes described herein. The system 200 may perform these processes based on processors executing software instructions stored by a computer-readable medium, such as memory 205 and/or server 203. A computer-readable medium may include any non-transitory memory device. A memory device includes memory space located inside of a single physical storage device or memory space spread across multiple physical storage devices. Software instructions may be read into memory 205 and/or server 203 from another computer-readable medium or from another device via communication interface. When executed, software instructions stored in memory 205 and/or server 203 may cause processor 208 to perform one or more processes described herein. Additionally, or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The present disclosure provides various advantages as follows:

User friendly input: The proposed system and method will only require selecting simple actions such as drawing shapes, typing texts and recording audio simultaneously for a digital canvas. Users do not require any multimedia skills and will enable the learning community to focus on the learning itself rather than managing complex software or web- applications.

SVG: The proposed system and method employ vector graphics, such as SVGs, which possess inherently infinite resolution and frequently offer significantly reduced file sizes, often by several orders of magnitude. Such outputs can be served even in low-bandwidth scenarios and support significantly more learning materials given a fixed digital space.

AI-enabled post-processing: The proposed system and method will allow the educators to correct or modify both voice as well as digital strokes at the post-processing level on the client-side. This is possible due to AI-enabled generation of punctuated voice transcripts including both speech-to-text and text-to-speech capabilities. Corrections on rendered strokes are possible due to software workflow of present disclosure that automatically maintains a log of all digital actions.

AI-enabled fact-validation: Learning community needs authentic and appropriate knowledge. The proposed application and the integrating web-platform will auto-monitor authenticity and appropriateness via AI-enabled profanity checkers and fact-validators.

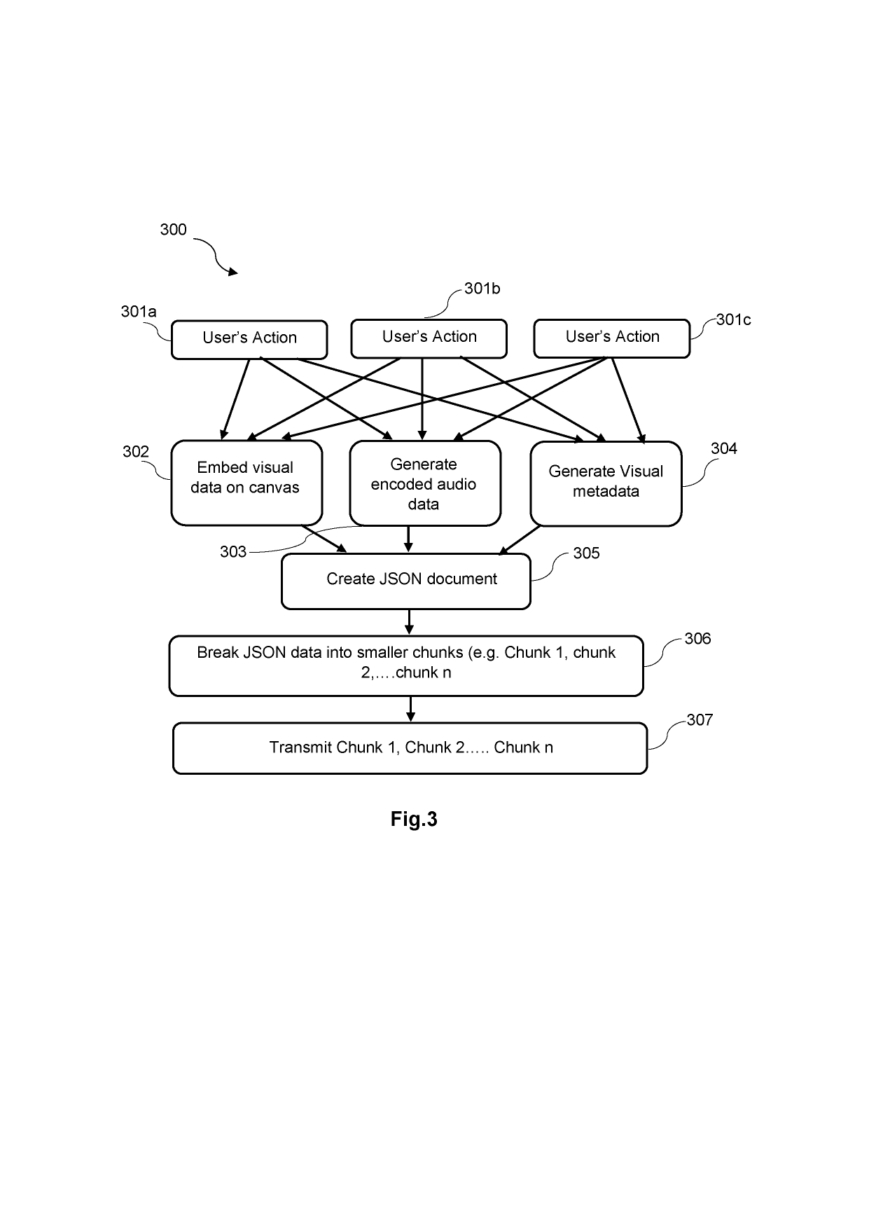

FIG. 3 illustrates a flowchart of an exemplary method for content editing workflow at client side (user 1 front end) in accordance with some embodiments of the present disclosure.

As also described earlier, when a user 206 wants to create content, the user 206 may access a web-based application through a secure network connection and send a login request to an authentication module 207. Based on the request, the authentication module 207 validates the credentials and allows the user to access the user 1 front end 201 for content editing. Further, in operation, the content editor 201a may receive user’s action through user’s action 301a-301c(at step 301). The user’s action may include recording voice or creating stroke on canvas or writing text on canvas individually or simultaneously. Further, the content editor 201a may feed these inputs into the SVG building module 201b for editing digital canvas or audio module.

At step 302, the SVG building module 201b may embed the visual data (representing strokes drawn or texts typed) onto the canvas so that the content creator can see that in real time. Moving further, the SVG building module 201b may generate an audio metadata by encoding a plurality of the audio-chunks received in the plurality of user inputs, wherein the plurality of the audio-chunks is produced by the user while recording user’s voice. At step 304, the SVG building module 201b may generate a visual metadata to describe a plurality of user visual actions onto the digital canvas, wherein the plurality of user visual actions is derived from the received plurality of the user inputs.

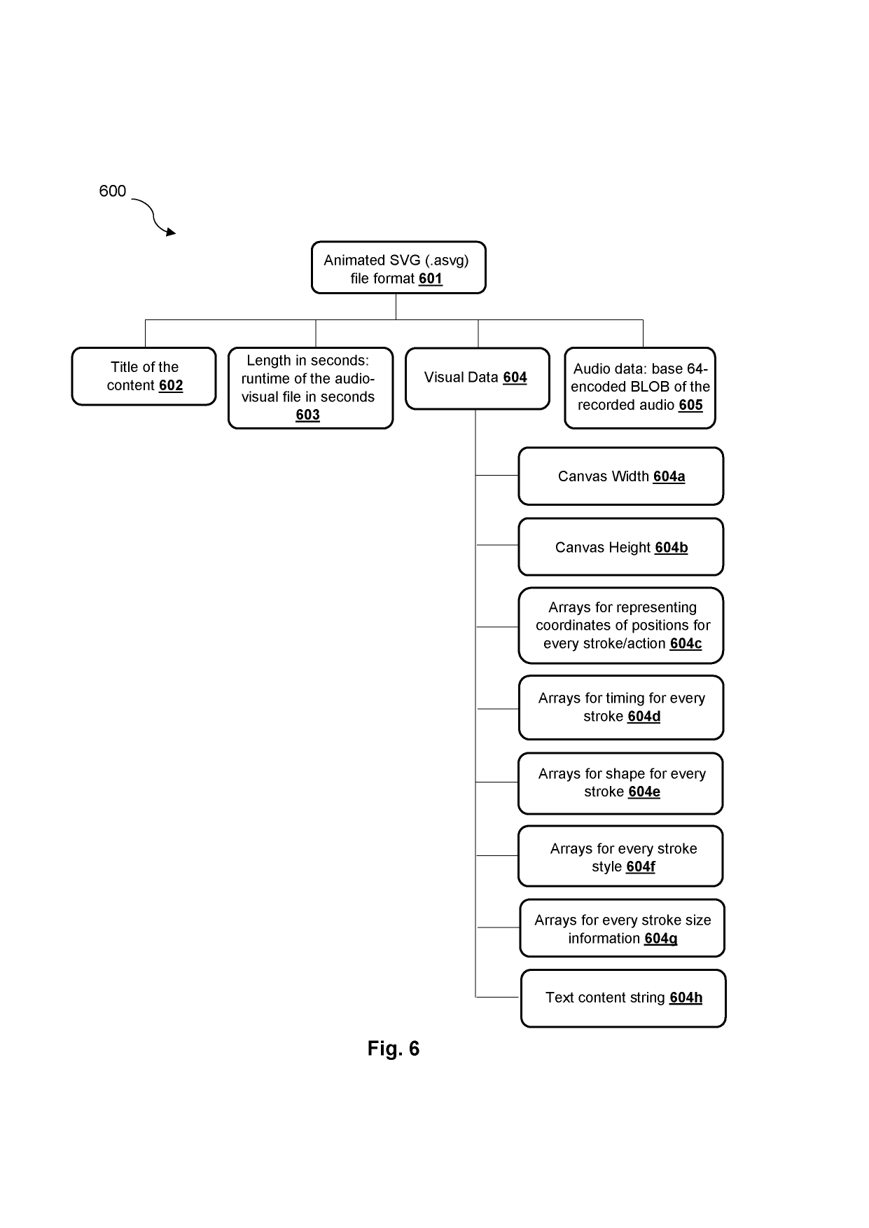

At step 305, the SVG building module 201b may generate an audio-integrated animated Scalable Vector Graphics (ASVG) format as an output to create the learning content. In order to create the ASVG format, the SVG building module 201b may create a JavaScript Object Notation (JSON) document comprising the audio metadata and the visual metadata. The description for ASVG file format is elaboratively described in later paragraphs with the help of FIG. 6.

In an exemplary embodiment, to generate the ASVG format, the SVG building module 201b may record a user-initiated panning or navigation action on the digital canvas during the content-creation process. For example, when the user, such as an educator, drags, shifts, or otherwise navigates across the digital canvas to reposition their view, the SVG building module 201b may capture the panning or navigation action as a distinct input stream generated alongside creating strokes, writing text, and voice recordings. Further, the SVG building module 201b may detect the initiation of such canvas-navigation actions and record the corresponding positional deltas, viewport coordinates, or viewport-shift vectors that may characterize the movement of the visible canvas region. Further, to ensure precise reconstruction of this navigation motion during the generation of the animated Scalable Vector Graphics (SVG) file at the server 203, the SVG building module 201b may encode the captured navigation data together with a visual snapshot of the digital canvas at the moment when the navigation action occurs. In an example without limitation, the visual snapshot provides a stable frame of reference representing the content layout at the time of the viewport transition, thereby enabling an accurate re-rendering of how the visual area changed over time. The navigation data and corresponding snapshots are incorporated into the JSON-based .asvg file either within the visual metadata object or as an auxiliary navigation data field ensuring that the panning motion is accurately reproduced during playback at user 2 front end 202.

At step 306, the SVG building module 201b may determine whether the size of the JSON document is larger than a pre‑defined size. Upon determining that the size of the JSON document is larger than the pre‑defined size, the SVG building module 201b may partition the JSON document into a plurality of smaller chunks, such that the size of each chunk does not exceed the pre‑defined size. The partitioning the JSON document into smaller chunks comprises assigning sequence identifiers to each chunk for accurate reconstruction at the server 203. In one non‑limiting example, the pre‑defined size threshold for the JSON document may be set to 5 MB. If the generated .asvg file exceeds this size, the system partitions the JSON document into smaller chunks, each not exceeding 1 MB, and assigns sequence identifiers to ensure accurate reconstruction at the server. In an example without limitation, a 4.8 MB JSON document may be divided into five chunks labelled Chunk‑1/5 to Chunk‑5/5, or a 9 MB JSON document may be divided into nine approximately 1‑MB chunks labelled sequentially as Seq‑001 through Seq‑009, thereby ensuring the server 203 can reconstruct the document even when the chunks arrive asynchronously or out of order. Setting a size limit is critical for optimizing network transmission and ensuring compatibility across devices with varying memory and bandwidth constraints. Large JSON files can lead to latency issues, failed uploads, or timeouts during transmission, particularly in low‑bandwidth environments. Partitioning the file into smaller chunks improves reliability, reduces the risk of data corruption, and enables efficient error handling during upload and reconstruction. This approach also ensures that the system remains scalable and responsive for real-time educational content delivery.

Further, to partition the JSON document, the SVG building module 201b may provide a sequence identifier to each smaller chunk, so that the JSON document can be accurately reconstructed at the server side when required.

At step 306, the SVG building module 201b may transmit the plurality of smaller chunks to a server 203 for further processing.

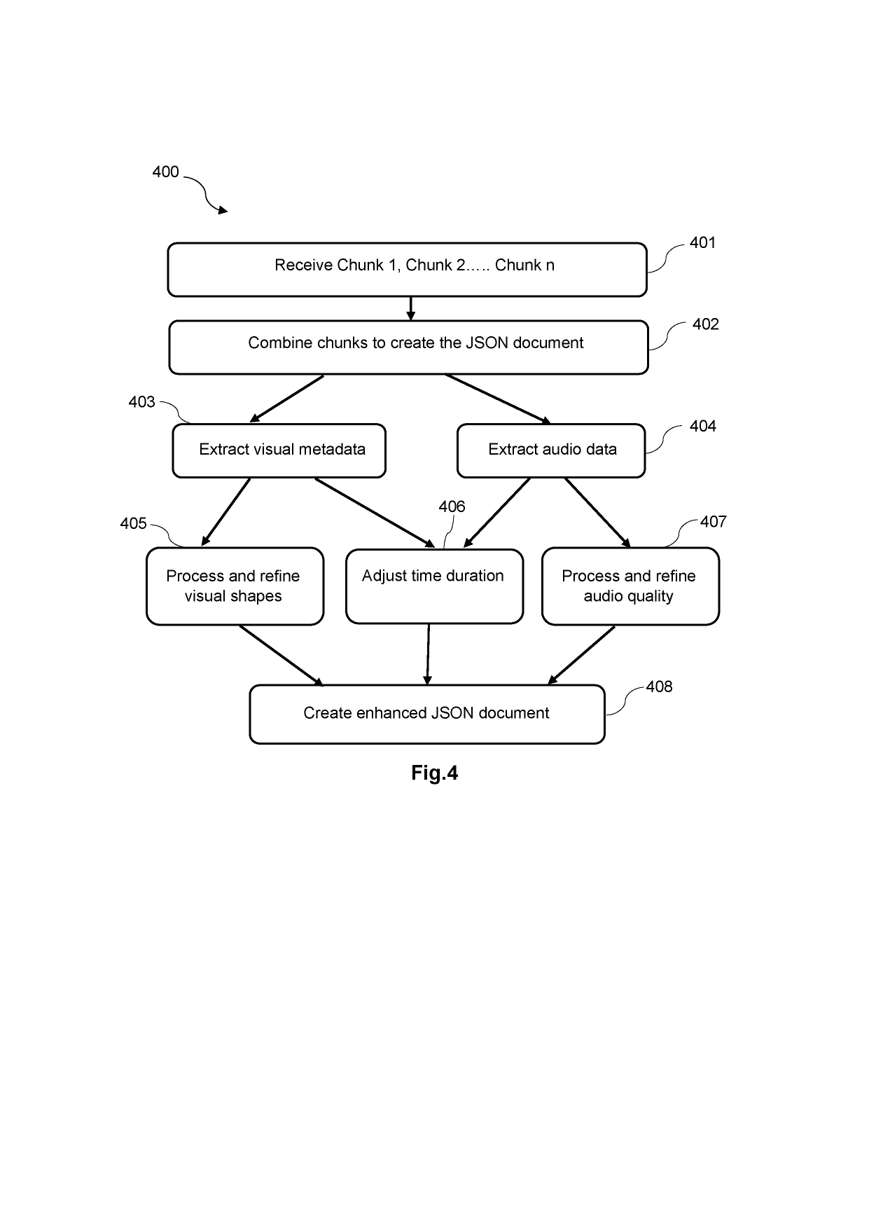

FIG. 4 illustrates an exemplary flow diagram for data processing at server side in accordance with some embodiments of the present disclosure.

At step 401, the processor 208 may receive a plurality of chunks of a JSON document, from a user front end module of a web-based application hosted by the server. At step 402, the processor 208 may reconstruct the JSON document by combining the plurality of smaller chunks, received from a client device. While reconstructing, the processor may validate sequence identifiers of the plurality of chunks to ensure accurate reconstruction for JSON document.

Further, at step 403, the processor 208 may extract an audio metadata and the visual metadata from the reconstructed JSON document. To extract audio metadata and the visual metadata from the reconstructed JSON document, the processor 208 may verify integrity of the reconstructed JSON document using a checksum or hash value. In general, a checksum or hash value is a short, fixed-length string of characters generated by applying a mathematical algorithm to a block of data (such as .asvg JSON file). Its purpose is to verify data integrity if even a single bit changes in the original file, the resulting checksum will differ, signalling corruption or tampering. In an example without limitation, the common algorithm for providing checksum or hash function may include MD5, SHA-1, SHA-256.

Moving ahead, the processor 208 may perform a plurality of operations to create an enhanced JSON document as the learning content. At step 404, the processor 208 may refine one or more visual shapes defined in the reconstructed JSON document for making the one or more visual shapes smoother. In a non-limiting embodiment, the processor 208 may apply a smoothing technique to smoothening the one or more visual shapes. In an example without limitation, the smoothening technique may be selected using an optimized exponential moving average method.

At step 405, the processor 208 may refine the audio quality defined in the reconstructed JSON document and removing unnecessary pauses from the audio data. While refining the audio quality, the processor 208 may apply noise reduction and dynamic range compression to the audio. In an example without limitation, the audio metadata is encoded using a compression technique selected from a group of MP3, AAC, or Opus formats to reduce file size.

Further, at step 406, the processor 208 may adjust duration of each stroke for synchronising visual part of the reconstructed JSON document with the audio part of the reconstructed JSON document. To adjust the the duration of each stroke, the processor 208 may map stroke time stamps to corresponding audio timestamp using a synchronizing technique.

At step 409, the processor 208 may create an enhanced JSON document after performing a plurality of operations and may generate a preview of the enhanced JSON document as a CSS-animated SVG for validation before deployment. The educator may watch the preview.

Finally, the processor 208 may store the enhanced JSON document in the memory 205 with a unique identifier for retrieval by an end user device and the JSON document may include metadata fields representing version control information for tracking edits. The processor 208 may further encrypt the enhanced JSON document prior to transmission to the end user device For example, the processor 208 may encrypt the enhanced JSON document in such a way that only the end user who has the access permission for that particular learning content, that person only access the learning content.

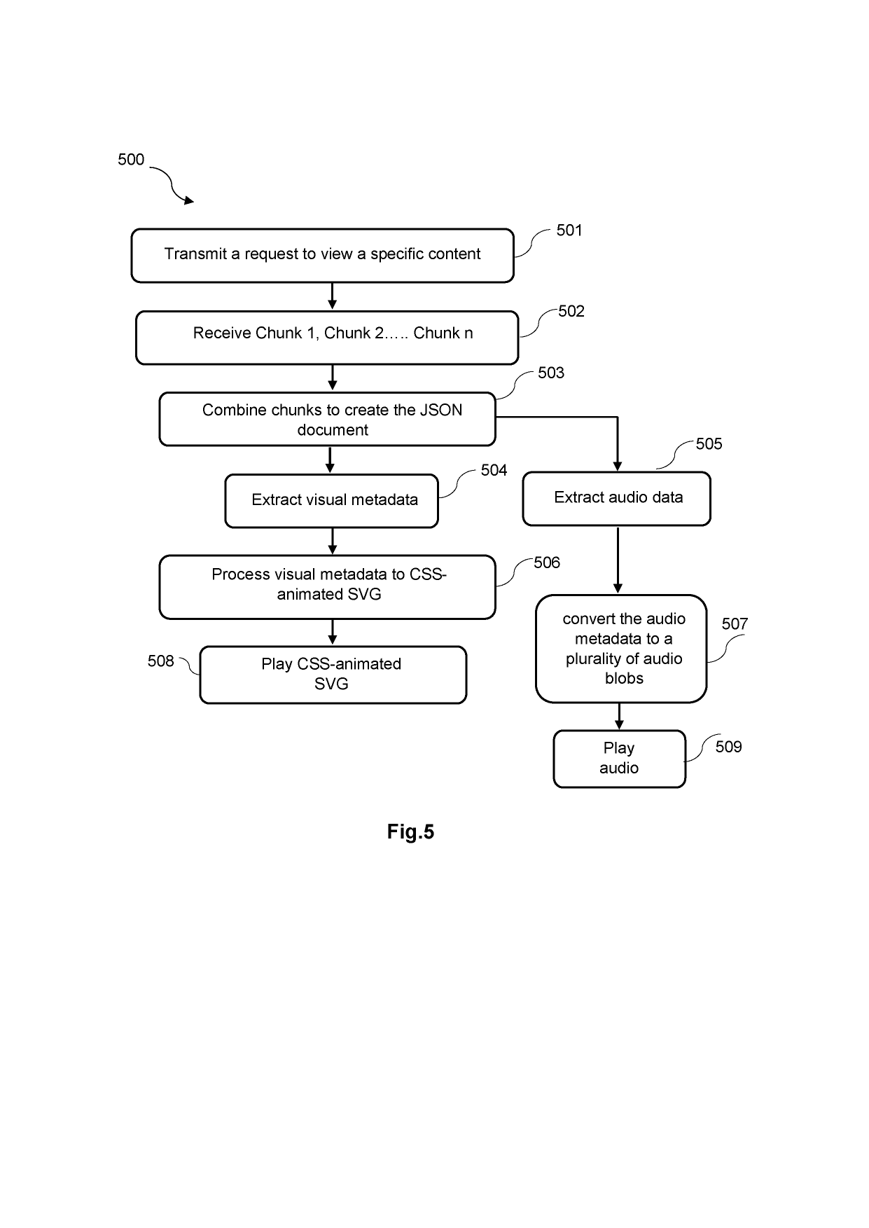

FIG. 5 illustrates an exemplary flow diagram for content viewing workflow at end user’s side (user 2 front end), in accordance with some embodiments of the present disclosure.

At step 501, the content viewer 202b may transmit a request to view a specific content on a user interface deployed by a web-based application. further, at step 502, the SVG viewing module 202a may receive a plurality of chunks of a JSON document, from the server 203, in respect of the requested transmitted.

At step 503, the SVG viewing module 202a may reconstruct the JSON document by combining the plurality of smaller chunks, received from the server 203.

At step 504, SVG viewing module 202a may extract a visual metadata from the re-created JSON document. At step 505, the SVG viewing module 202a may extract the audio metadata from the re-created JSON document.

Moving further, at step 506 the SVG viewing module 202a may transform the visual metadata to a Cascading Style Sheets (CSS) animated SVG. In an exemplary embodiment, during playback at user2 front end 202 the SVG viewing module 202a may decode the encoded navigation information (as described in FIG. 3) and reconstruct the panning action by animating the viewport transition using CSS‑based animation techniques consistent with other visual action rendering disclosed herein.

At step 507, the SVG viewing module 202a may convert the audio metadata to a plurality of audio blobs. Further, at step 508 and 509, the content viewer may control playing of the CSS-animated SVG and the plurality of audio blobs on a display of the end user’s device such that the CSS-animated SVG audio and the plurality of audio blobs are being played in synchronization on the display of the end user’s device.

Thus, the method allows the animated SVG to mimic the educator’s original panning behavior, ensuring that the learner experiences the same progression of visual focus as intended by the educator. Combined with synchronized audio playback, this ensures that transitions such as shifting attention from one diagram section to another appear natural, smooth, and temporally aligned with the recorded narration.

### Non-limiting example:

Consider an educator or teacher is using a web-based application called “EduCanvas” to create an interactive learning module on “Photosynthesis” using SaaS platform. The educator logs into the platform and opens a digital canvas that supports simultaneous input of text, shapes, and audio.

### Educator side (content capture and .asvg creation).

An educator opens the web‑based content editor, draws a leaf outline and chloroplasts on a digital canvas while narrating, and types the label “Photosynthesis occurs in chloroplasts.” As these actions occur, the user1 front end such as educator device simultaneously renders the strokes/text on the canvas and generates visual metadata (screen dimensions, coordinate arrays for each stroke, timing arrays for start/end of each action, tool type/color/size, and any typed text), along with audio metadata encoded from the live narration (e.g., Opus), all of which are assembled into a JSON‑based .asvg record containing at least a title, duration, visual data, and audio data fields; a checksum is included to support integrity verification. If the file size exceeds a predefined threshold, the educator device partitions the JSON into smaller chunks with sequence identifiers before transmission. In addition, while creating the lesson, the educator also shifts the digital canvas view to focus on another section of the diagram or text, for example diagram to text. Then the system records this user-initiated navigation along with a visual snapshot of the canvas to enable precise reconstruction of the panning motion to reconstruct the animated SVG during playback in the end user device.

### Server side (AI‑enabled post‑processing).

Upon receipt the smaller chunks of the JSON documents, the server reconstructs the JSON document from its chunk sequence identifiers and verifies integrity using the included checksum/hash; it then extracts the audio and visual metadata for AI‑enabled post‑processing. The server refines the educator’s drawn shapes by applying smoothing (e.g., Bézier/spline fitting) to the stroke coordinate arrays, so the leaf and chloroplast contours render cleanly without hand‑jitter, while preserving each stroke’s tool attributes. It also improves the narration by applying noise reduction and dynamic range conditioning and removing unnecessary pauses to tighten pacing. Finally, it adjusts stroke durations and timing offsets so that the completion of the leaf outline and appearance of the chloroplast contour are synchronized to the corresponding spoken words (e.g., “leaf,” “chloroplasts”). Then, the enhanced JSON is stored with version‑control metadata and can be lossless compressed and encrypted before distribution, with an optional CSS‑animated SVG preview generated for validation.

Since, learning community needs authentic and appropriate knowledge. Optionally, the proposed application and the integrating web-platform auto-monitors authenticity and appropriateness via AI-enabled profanity checkers and fact-validators. If any mistake is found, for example educator said that “photosynthesis occurred at night” the AI-enabled profanity checkers and fact-validators edits the content and generate a preview of the learning content to show to the educator before deployment in the web-based application “EduCanvas”.

### End‑user side (playback and synchronized experience).

When a student requests the Photosynthesis lesson, their device receives the enhanced JSON chunks, re‑creates the .asvg, and transforms the visual metadata into a CSS‑animated SVG while decoding the audio into playable blobs; the viewer (student) controls playback such that the smoothed drawing of the leaf and the chloroplast highlights remain perfectly aligned with the educator’s cleaned narration. Furthermore, during playback, the panning action (performed at educator device) is decoded in the viewer’s device such that the recorded navigation movement is reproduced seamlessly through CSS-based animation, ensuring that the student experiences the same guided visual transition originally performed by the educator. This yields a lightweight, scalable, synchronized learning experience in the browser, with vector fidelity and reduced bandwidth footprint compared to traditional video.

FIG. 6 illustrates an exemplary structure of an audio-integrated animated Scalable Vector Graphics (SVG) file, stored with an .asvg extension, in accordance with the present disclosure. The .asvg file is implemented as a JSON-based format comprising multiple fields that collectively represent the audio-visual learning content. As shown in the illustrated figure, the file may include a title field 602 indicating the title of the content and a duration field 603 specifying the total runtime of the audio-visual content in seconds. The file may further comprises a visual data object 604 that encapsulates detailed visual metadata, including canvas dimensions such as width 604a and height 604b. the visual date may further comprise arrays representing coordinates of strokes or actions 604c, timing arrays for start and end times of each stroke 604d, arrays for shape information 604e (for example round, square, polynomial etc. ), arrays for stroke style attributes 604f (for example color of the shape), arrays for stroke size information 604g (for example stroke dimensions in millimetre) and arrays for text content strings typed during the creation process 604h. Additionally, the .asvg file includes an audio data field 605 comprising an encoded representation of the recorded audio, such as a base 64-encoded BLOB. This structured format enables efficient reconstruction, integrity verification, and synchronized rendering of CSS-animated SVG visuals with corresponding audio playback, thereby providing a lightweight and scalable solution for interactive learning content.

FIG. 7 illustrates a flowchart of an exemplary method 700 for content editing workflow at client side (user 1) in accordance with some embodiments of the present disclosure. The order in which the method 700 is described is not intended to be construed as a limitation, and any number of the described method blocks may be combined in any order to implement the method. Additionally, individual blocks may be deleted from the methods without departing from the spirit and scope of the subject matter described. Furthermore, the method can be implemented in any suitable hardware, software, firmware, or combination thereof. However, for ease of explanation, in the embodiments described below, the method 700 may be implemented by the respective components of FIG. 2.

At step 701, the method 700 may include receiving a plurality of user inputs on a digital canvas deployed by a web-based application. In one implementation, a content editor 201a may receive a plurality of user inputs on a digital canvas deployed by a web-based application.

At step 702, the method 700 may include simultaneously generating a visual representation of the plurality of user inputs on the digital canvas in real time. In one implementation, the SVG building module 201b may simultaneously generate a visual representation of the plurality of user inputs on the digital canvas in real time.

At step 703, the method 700 may include generating an audio-integrated animated Scalable Vector Graphics (SVG) format as an output to create the learning content. In one implementation, the SVG building module 201b may generate an audio-integrated animated Scalable Vector Graphics (SVG) format as an output to create the learning content.

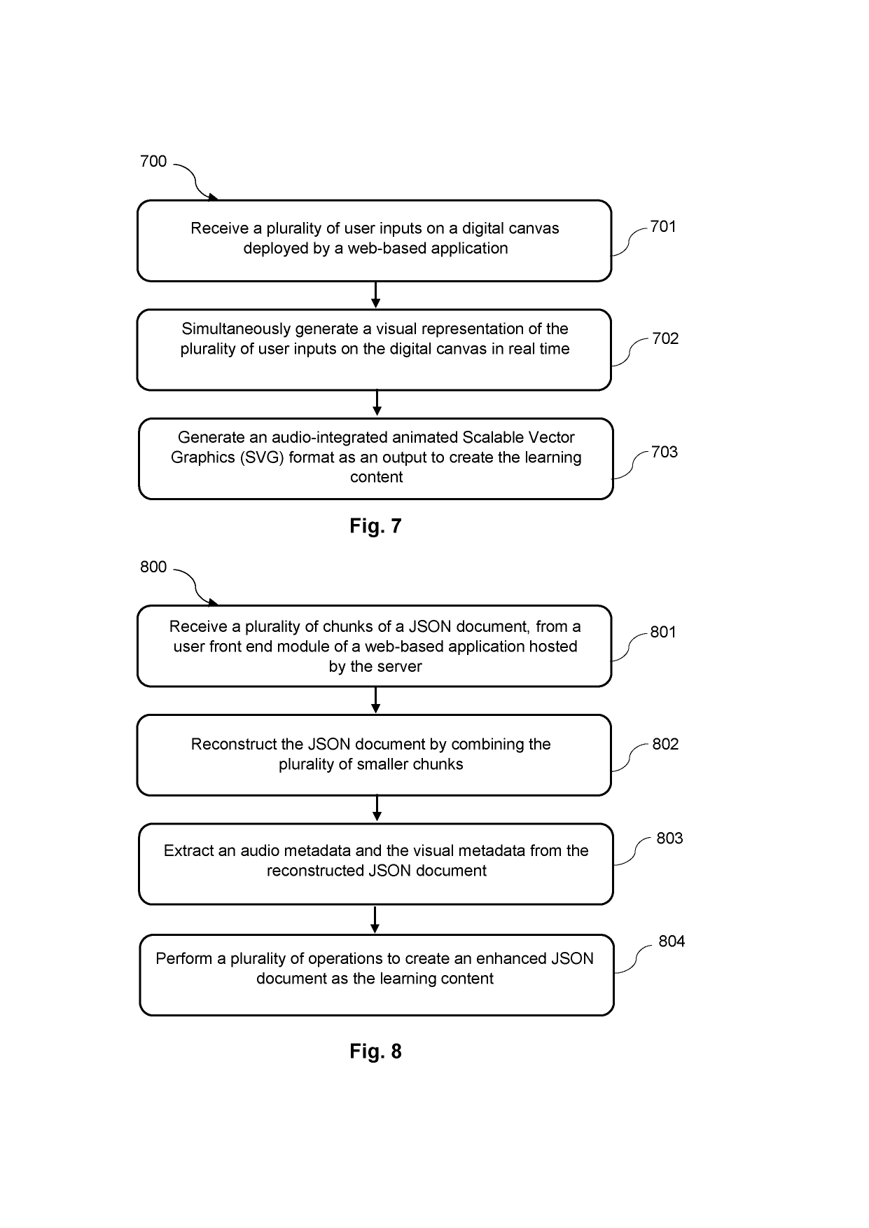

FIG. 8 illustrates a flowchart of an exemplary method 800 for data processing at server side, in accordance with some embodiments of the present disclosure. The order in which the method 800 is described is not intended to be construed as a limitation, and any number of the described method blocks may be combined in any order to implement the method. Additionally, individual blocks may be deleted from the methods without departing from the spirit and scope of the subject matter described. Furthermore, the method can be implemented in any suitable hardware, software, firmware, or combination thereof. However, for ease of explanation, in the embodiments described below, the method 800 may be implemented by the respective components of FIG. 2.

At step 801, the method 800 may include receiving a plurality of chunks of a JSON document, from a user front end module of a web-based application hosted by the server. In one implementation, the processor 208 may receive a plurality of chunks of a JSON document, from a client device.

At step 802, the method 800 may include reconstructing the JSON document by combining the plurality of smaller chunks. In one implementation, the processor 208 may reconstruct the JSON document by combining the plurality of smaller chunks.

At step 803, the method 800 may include extracting an audio metadata and the visual metadata from the reconstructed JSON document. In one implementation, the processor 208 may extract an audio metadata and the visual metadata from the reconstructed JSON document.

At step 804, the method 800 may include performing a plurality of operations to create an enhanced JSON document as the learning content. In one implementation, the processor 208 may perform a plurality of operations to create an enhanced JSON document as the learning content.

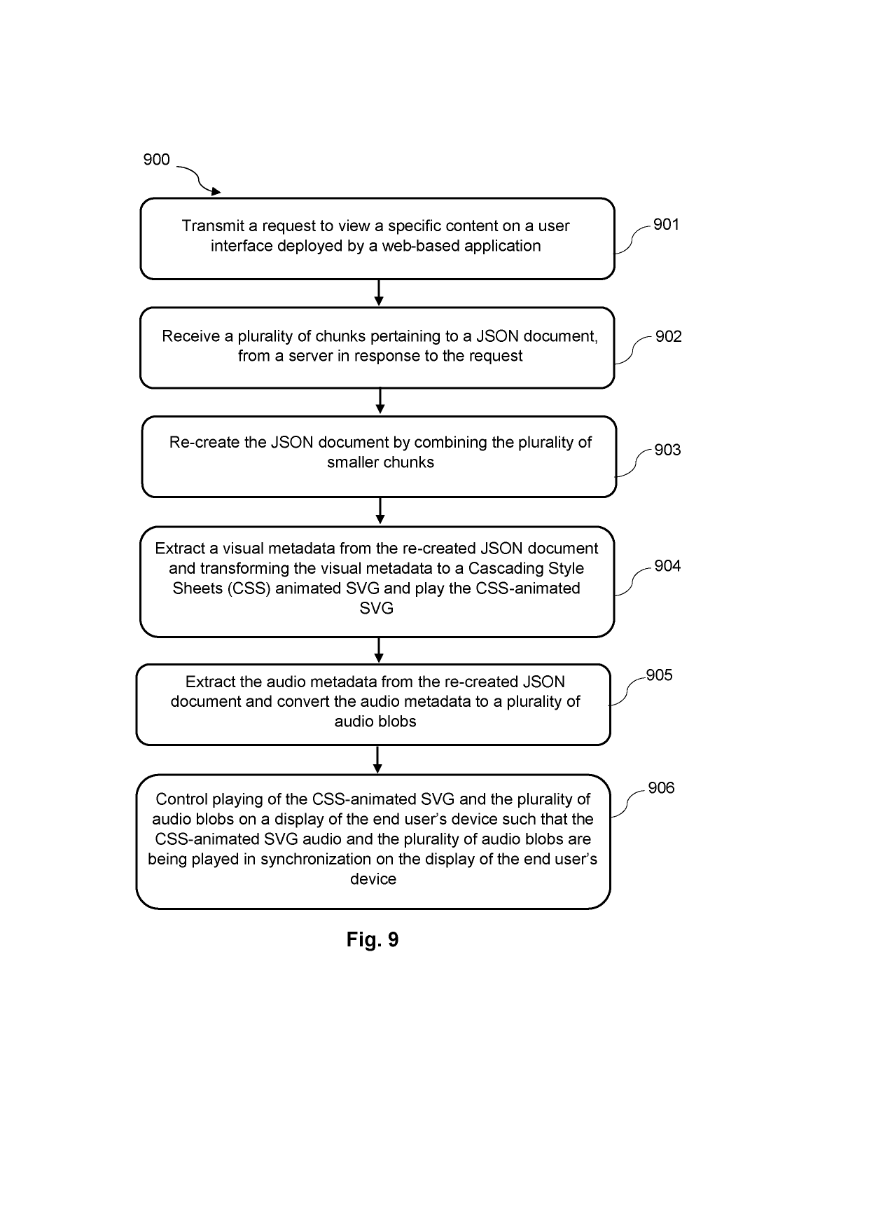

FIG. 9 illustrates a flowchart of an exemplary method 900 for content viewing workflow at end user’s side (user 2 front end), in accordance with some embodiments of the present disclosure. The order in which the method 900 is described is not intended to be construed as a limitation, and any number of the described method blocks may be combined in any order to implement the method. Additionally, individual blocks may be deleted from the methods without departing from the spirit and scope of the subject matter described. Furthermore, the method can be implemented in any suitable hardware, software, firmware, or combination thereof. However, for ease of explanation, in the embodiments described below, the method 900 may be implemented by the respective components of FIG. 2.

At step 901, the method 900 may include transmitting a request to view a specific content on a user interface deployed by a web-based application. In one implementation, a SVG viewing module 202a may transmit a request to view a specific content on a user interface deployed by a web-based application.

At step 902, the method 900 may include receiving a plurality of chunks pertaining to a JSON document, from a server in response to the request. In one implementation, the SVG viewing module 202a may receive a plurality of chunks pertaining to a JSON document, from a server in response to the request.

At step 903, the method 900 may include re-creating the JSON document by combining the plurality of smaller chunks. In one implementation, the SVG viewing module 202a may re-create the JSON document by combining the plurality of smaller chunks.

At step 904, the method 900 may include extracting a visual metadata from the re-created JSON document and transforming the visual metadata to a Cascading Style Sheets (CSS) animated SVG and play the CSS-animated SVG. In one implementation, the SVG viewing module 202a may extract a visual metadata from the re-created JSON document and transforming the visual metadata to a Cascading Style Sheets (CSS) animated SVG and play the CSS-animated SVG.

At step 905, the method 900 may include extracting the audio metadata from the re-created JSON document and convert the audio metadata to a plurality of audio blobs. In one implementation, the SVG viewing module 202a may extract the audio metadata from the re-created JSON document and convert the audio metadata to a plurality of audio blobs.

At step 906, the method 900 may include controlling playing of the CSS-animated SVG and the plurality of audio blobs on a display of the end user’s device such that the CSS-animated SVG audio and the plurality of audio blobs are being played in synchronization on the display of the end user’s device. In one implementation, the content viewer 202b may controlling playing of the CSS-animated SVG and the plurality of audio blobs on a display of the end user’s device such that the CSS-animated SVG audio and the plurality of audio blobs are being played in synchronization on the display of the end user’s device.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer- readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Although embodiments or aspects have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A method for creating a learning content for a client device, comprising:
receiving a plurality of user inputs on a digital canvas deployed by a web-based application;
simultaneously generating a visual representation of the plurality of user inputs on the digital canvas in real time; and
generating an audio-integrated animated Scalable Vector Graphics (SVG) format as an output to create the learning content.

2. The method of claim 1, wherein the plurality of user inputs may comprise at least one of: drawing shapes, typing texts and recording voice of the user.

3. The method of claim 1, wherein generating the audio-integrated animated Scalable Vector Graphics (SVG) format comprises:
generating a visual metadata to describe a plurality of user visual actions onto the digital canvas, wherein the plurality of user visual actions is derived from the received plurality of the user inputs; and
generating an audio metadata by encoding a plurality of the audio-chunks received in the plurality of user inputs, wherein the plurality of the audio-chunks is produced by the user while recording user’s voice.

4. The method of claim 2, wherein generating the audio-integrated animated SVG format further comprises storing generated content in a file having an .asvg extension, the .asvg file being a JSON-based format that comprises at least of:
a title field representing a title of the content;
a duration field representing the length of the audio-visual content;
a visual data object comprising:
dimensions of the recorded screen;
coordinate arrays representing positions of strokes or actions;
timing arrays representing start and end times for each stroke or action;
arrays representing tool type, color, and size information for each stroke or action; and
arrays representing text typed during each stroke or action; and
an audio data field comprising an encoded audio representation.

5. The method of claim 1, wherein generating the audio-integrated animated SVG format further comprises:
recording a panning action on the digital canvas; and
encoding the recorded panning action with a corresponding visual snapshot of the digital canvas, to enable reconstruction of the panning action during reconstruction of the animated SVG file at a server.

6. The method of claim 3, further comprising:
creating a JavaScript Object Notation (JSON) document comprising the audio metadata and the visual metadata; and
determining if a size of the JSON document is larger than a pre-defined size;
upon determining that the size of the JSON document is larger than the pre-defined size:
partitioning the JSON document into a plurality of smaller chunks, such that the size of each chunk does not exceed the pre-defined size, wherein partitioning the JSON document into smaller chunks comprises assigning sequence identifiers to each chunk for accurate reconstruction at a server; and
transmitting the plurality of smaller chunks to the server.

7. The method of claim 1, wherein the audio-integrated animated SVG format is generated using a Cascading Style Sheets (CSS) animation technique for rendering visual actions.

8. The method of claim 3, wherein the visual metadata further comprises arrays representing tool type, color, and size information for each stroke or action.

9. The method of claim 3, wherein the audio metadata is encoded using a compression technique selected at least from a group of Moving Picture Experts Group (MPEG) ‑1 Audio Layer 3 (MP3), Advanced Audio Coding (AAC), or Opus formats to reduce file size.

10. The method of claim 4, wherein the .asvg file further comprises a checksum field for verifying integrity of the content during transmission.

11. The method of claim 1, further comprising applying AI-enabled post-processing to refine one or more visual shapes and remove unnecessary pauses from the audio data.

12. A method for creating a learning content at a server, comprising:
receiving a plurality of chunks of a JSON document, from a user front end module of a web-based application hosted by the server;
reconstructing the JSON document by combining the plurality of smaller chunks;
extracting an audio metadata and the visual metadata from the reconstructed JSON document; and
performing a plurality of operations to create an enhanced JSON document as the learning content.

13. The method of claim 12, wherein performing the plurality of operations to create the enhanced JSON document comprising at least one of:
refining one or more visual shapes defined in the reconstructed JSON document for making the one or more visual shapes smoother;
refining audio quality defined in the reconstructed JSON document and removing unnecessary pauses from the audio data; and
adjusting duration of each stroke for synchronising visual part of the reconstructed JSON document with the audio part of the reconstructed JSON document, wherein adjusting the duration of each stroke comprises mapping stroke timestamps to corresponding audio timestamps using a synchronization technique.

14. The method of claim 12, wherein reconstructing the JSON document comprises validating sequence identifiers of the plurality of chunks to ensure accurate reconstruction.

15. The method of claim 12, wherein extracting the audio metadata and the visual metadata further comprises verifying integrity of the reconstructed JSON document using a checksum or hash value.

16. The method of claim 12, wherein performing the plurality of operations further comprises compressing the enhanced JSON document using a lossless compression technique prior to storage or transmission.

17. The method of claim 13, wherein refining audio quality comprises applying noise reduction and dynamic range compression to the audio data.

18. The method of claim 13, wherein refining one or more visual shapes comprises applying a smoothing technique using an optimized exponential moving average method.

19. The method of claim 12, further comprising storing the enhanced JSON document in a database with a unique identifier for retrieval by an end user device.

20. The method of claim 12, wherein the enhanced JSON document includes metadata fields representing version control information for tracking edits.

21. The method of claim 12, further comprising encrypting the enhanced JSON document prior to transmission to an end user device.

22. The method of claim 12, further comprising generating a preview of the enhanced JSON document as a CSS-animated SVG for validation before deployment.

23. A method for creating a learning content for an end user’s device, comprising:
transmitting a request to view a specific content on a user interface deployed by a web-based application;
receiving a plurality of chunks pertaining to a JSON document, from a server in response to the request;
re-creating the JSON document by combining the plurality of smaller chunks;
extracting a visual metadata from the re-created JSON document and transforming the visual metadata to a Cascading Style Sheets (CSS) animated SVG and play the CSS-animated SVG,
extracting the audio metadata from the re-created JSON document and convert the audio metadata to a plurality of audio blobs; and
controlling playing of the CSS-animated SVG and the plurality of audio blobs on a display of the end user’s device such that the CSS-animated SVG audio and the plurality of audio blobs are being played in synchronization on the display of the end user’s device.

24. A server for creating a learning content, comprising:
a memory; and
a processor coupled with the memory and configured to:
receive a plurality of chunks of a JSON document, from a user front end module of a web-based application hosted by the server;
reconstructing the JSON document by combining the plurality of smaller chunks;
extract an audio metadata and the visual metadata from the reconstructed JSON document; and
perform a plurality of operations to create an enhanced JSON document as the learning content.

25. The server of claim 24, wherein to perform the plurality of operations to create the enhanced JSON document, the processor is configured to:
refine one or more visual shapes defined in the reconstructed JSON document for making the one or more visual shapes smoother;
refine audio quality defined in the reconstructed JSON document and remove unnecessary pauses from the audio data; and
adjust duration of each stroke for synchronizing a visual part of the reconstructed JSON document with an audio part of the reconstructed JSON document, wherein adjusting the duration of each stroke comprises mapping stroke timestamps to corresponding audio timestamps using a synchronization technique.

26. The server of claim 24, wherein to reconstruct the JSON document, the processor is configured to validate sequence identifiers of the plurality of chunks to ensure accurate reconstruction.

27. The server of claim 24, wherein to extract the audio metadata and the visual metadata, the processor is configured to verify integrity of the reconstructed JSON document using a checksum or hash value.

28. The server of claim 24, wherein to perform the plurality of operations, the processor is configured to compress the enhanced JSON document using a lossless compression technique prior to storage or transmission.

29. The server of claim 25, wherein to refine audio quality, the processor is configured to apply noise reduction and dynamic range compression to the audio data.

30. The server of claim 25, wherein to refine one or more visual shapes, the processor is configured to apply a smoothing technique using an optimized exponential moving average method.

31. The server of claim 25, wherein to store the enhanced JSON document, the processor is configured to save the enhanced JSON document in a database with a unique identifier for retrieval by an end-user device.

32. The server of claim 24, wherein the enhanced JSON document includes metadata fields representing version control information for tracking edits.

33. The server of claim 24, wherein to transmit the enhanced JSON document, the processor is configured to encrypt the enhanced JSON document prior to transmission to an end-user device.

34. The server of claim 24, wherein to validate the enhanced JSON document before deployment, the processor is configured to generate a preview of the enhanced JSON document as a CSS-animated SVG.

35. A non-transitory computer-readable medium storing instructions that, when executed by one or more processors of a server, cause the server to perform operations comprising:
receiving a plurality of user inputs on a digital canvas deployed by a web-based application hosted at the server;
simultaneously generating a visual representation of the plurality of user inputs on the digital canvas in real time; and
generating an audio-integrated animated Scalable Vector Graphics (SVG) format as an output to create learning content.

36. A non-transitory computer-readable medium storing instructions that, when executed by one or more processors of a server, cause the server to perform operations comprising:
receiving a plurality of chunks of a JSON document from a client device;
reconstructing the JSON document by combining the plurality of chunks;
extracting audio metadata and visual metadata from the reconstructed JSON document; and
performing a plurality of operations to create an enhanced JSON document as learning content.
